(19) United States
(12) Patent Application Publication
(10) Pub. No.: US 2008/0230630 A1
(43) Pub. Date: Sep. 25, 2008

(54) COLOR MATCHING SYSTEM AND METHOD

(75) Inventor: Mark E. Charpie, Ottawa Lake, MI (US)

Correspondence Address: FLETCHER YODER (ILLINOIS TOOL WORKS INC.), P.O. BOX 692289, HOUSTON, TX, 77269-2289, US

(73) Assignee: Illinois Tool Works Inc., Glenview, IL (US)

(21) Appl. No.: 11/683,948

(22) Filed: Mar. 8, 2007

(51) Int. Cl. A62C 13/62

(52) U.S. Cl. 239/304; 239/345

(57) ABSTRACT

A system, in one embodiment, is provided with a fluid container configured to mount on a spray device, and a color additive applicator coupled to the fluid container. A system, in another embodiment, is provided with a color matching support configured to receive a plurality of different color sources, wherein the color matching support is configured to enable the plurality of different color sources to provide different colored additives to a fluid mixing chamber of a spray device. A system, in a further embodiment, is provided with a color additive applicator configured to couple to a fluid container disposed on a spray coating device.

### FIELD OF THE INVENTION

The invention relates generally to spray devices and, more particularly, to color matching of paints and other finishing products.

### BACKGROUND

This section is intended to introduce the reader to various aspects of art that may be related to various aspects of the present invention, which are described and/or claimed below. This discussion is believed to be helpful in providing the reader with background information to facilitate a better understanding of the various aspects of the present invention. Accordingly, it should be understood that these statements are to be read in this light, and not as admissions of prior art.

In certain finishing applications, such as automotive refinishing, it is desirable to match the color of a new finish with an existing finish. For example, if an automobile needs body repair, then an attempt is made to match new paint with the existing paint already on the automobile. Unfortunately, the current practice involves trial and error to match the colors. For example, a painter typically places a container on a scale in a paint mixing room, and then adds different amounts of color (e.g., tint) to create a mixture according to a specified formula for the automobile. Next, the painter places the container in a paint shaker to make the mixture more uniform. The painter then applies a solvent to the mixture to reduce the mixture to a suitable viscosity for spraying. Subsequently, the painter pours the mixture from the container into the paint cup for the spray gun. Finally, the painter sprays the mixture onto the automobile and compares the original and new colors. If the colors do not match, then the painter must return to the paint mixing room for additional mixing. Unfortunately, this trial and error process results in downtime of the spray gun while the painter is away mixing the paint.

### BRIEF DESCRIPTION

A system, in one embodiment, is provided with a fluid container configured to mount on a spray device, and a color additive applicator coupled to the fluid container. A system, in another embodiment, is provided with a color matching support configured to receive a plurality of different color sources, wherein the color matching support is configured to enable the plurality of different color sources to provide different colored additives to a fluid mixing chamber of a spray device. A system, in a further embodiment, is provided with a color additive applicator configured to couple to a fluid container disposed on a spray coating device.

### DRAWINGS

These and other features, aspects, and advantages of the present invention will become better understood when the following detailed description is read with reference to the accompanying drawings in which like characters represent like parts throughout the drawings, wherein:

FIG. 1 is a diagram illustrating an embodiment of a spray coating system having a unique fluid mixing and color matching system associated with a fluid supply for a spray device;

FIG. 2 is a flow chart illustrating an embodiment of a spray coating process;

FIGS. 3 and 4 are cross-sectional side views of different embodiments of a spray coating device used in the spray coating system and method of FIGS. 1 and 2;

FIGS. 5 and 6 are top views of different embodiments of color matching supports for various color sources configured to couple with the fluid supplies of FIGS. 1-4; and

FIGS. 7 and 8 are diagrams of different embodiments of color matching applicators configured to couple with the color matching supports of FIGS. 1-6.

### DETAILED DESCRIPTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

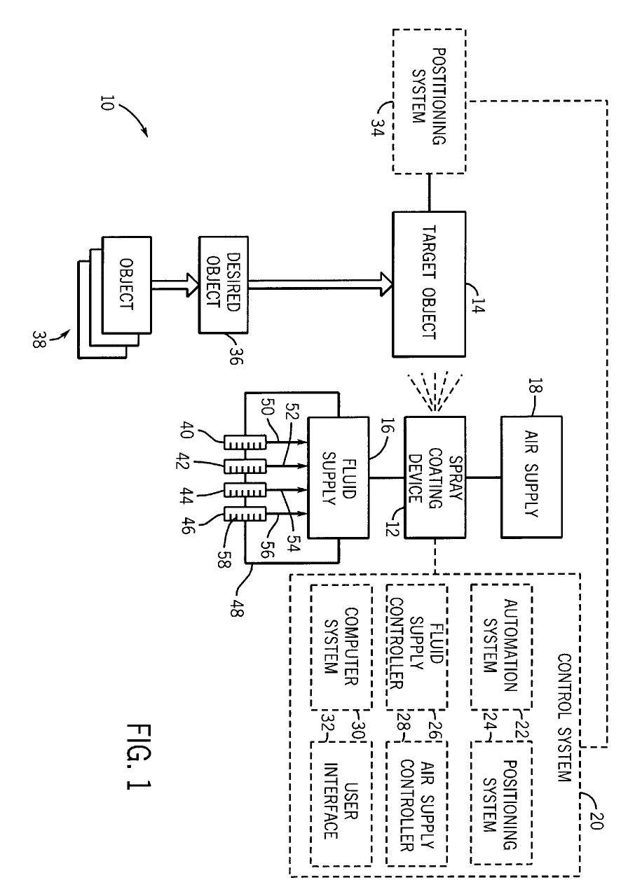

FIG. 1 is a flow chart illustrating an exemplary spray coating system 10, which includes a spray coating gun 12 for applying a desired coating to a target object 14. As discussed in further detail below, the disclosed embodiments relate to a unique on-site and/or on-gun mixing and color matching system for the coating fluid. Specifically, various colors (e.g., red, blue, green) can be quickly added to the coating fluid to achieve a desired color, such that the coating fluid can be color matched with a color of the target object 14. These various colors may be disposed in small syringes, pipettes, or other suitable applicators, which are coupled to the fluid supply 16 for the spray coating gun 12. For example, the applicators may be disposed directly on the fluid supply 16 mounted on the spray coating gun 12. Advantageously, this enables the user to quickly add various colors to the mixture, shake the container, and then apply another coat in an attempt to color match.

In certain embodiments, the spray coating gun 12 may include an air atomizer, a rotary atomizer, an electrostatic atomizer, or any other suitable spray formation mechanism. The spray coating gun 12 may be coupled to a variety of supply and control systems, such as the fluid supply 16, an air supply 18, and a control system 20. The control system 20 facilitates control of the fluid and air supplies 16 and 18 and ensures that the spray coating gun 12 provides an acceptable quality spray coating on the target object 14. For example, the control system 20 may include an automation system 22, a positioning system 24, a fluid supply controller 26, an air supply controller 28, a computer system 30, and a user interface 32. The control system 20 also may be coupled to a positioning system 34, which facilitates movement of the target object 14 relative to the spray coating gun 12. According, the spray coating system 10 may provide a computer-controlled mixture of coating fluid, fluid and air flow rates, and spray pattern. Moreover, the positioning system 34 may include a robotic arm controlled by the control system 20, such that the spray coating gun 12 covers the entire surface of the target object 14 in a uniform and efficient manner.

As illustrated in FIG. 1, the fluid supply 16 is configured to receive a color additive or tint from a plurality of color sources 40, 42, 44, and 46, which may be coupled to the fluid supply 16 via a support 48. For example, the fluid supply 16 may be a container, while the support 48 is a lid coupled to the container. The color sources 40, 42, 44, and 46 may include a liquid, paste, gel, solid, or other form, which can be easily applied into the fluid supply 16 as indicated by arrows 50, 52, 54, and 56, respectively. In some embodiments, a larger or smaller number of color sources can be used with the fluid supply 16. For example, the fluid supply 16 can be used with 1, 2, 3, 4, 5, 6, 7, 8, 9, 10, or more color sources similar to the color sources 40, 42, 44, and 46. These color sources 40, 42, 44, and 46 may be syringes, pipettes, flexible squeeze applicators, or other suitable graduated containers with marks 58 for units of measurement, e.g., mass or volume. The color sources 40, 42, 44, and 46, in some embodiments, include manual triggers or actuators. For example, the color sources 40, 42, 44, and 46 may include plungers that move a color additive through a barrel. Other embodiments of the color sources 40, 42, 44, and 46 have triggers coupled to automatic drives, e.g., electronic, air-powered, hydraulic, and so forth. In addition, the color sources 40, 42, 44, and 46 can include one or more valves, such as gate valves, pinch valves, check valves, electronic valves, or a combination thereof, to facilitate flow control of the colors relative to the fluid supply 12.

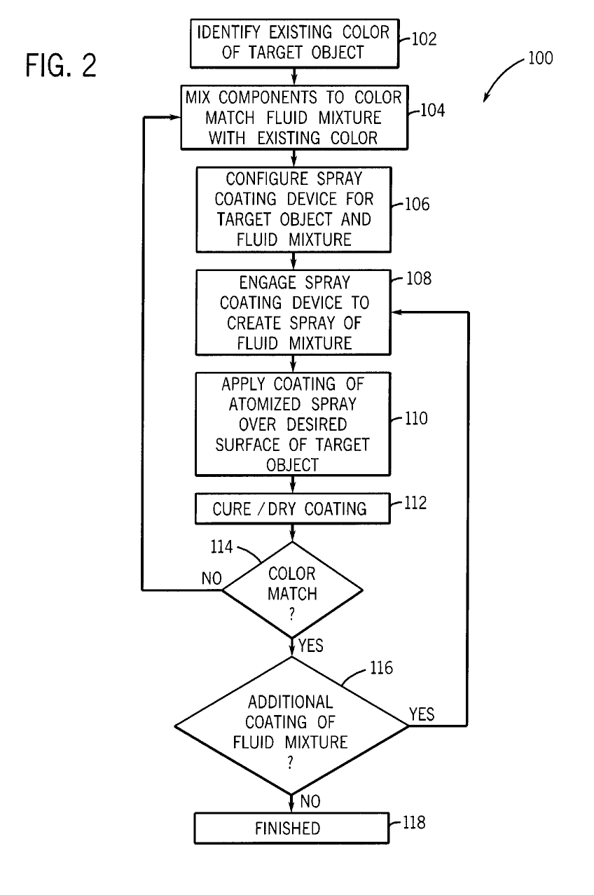

FIG. 2 is a flow chart of an exemplary spray coating process 100 for applying a desired spray coating to the target object 14. As illustrated, the process 100 proceeds by identifying the existing color (e.g., stock paint color) of the target object 14 (block 102). The process 100 then proceeds by mixing components (e.g., different colors or tints) to create a fluid mixture believed to be a color match with the existing color for application to a spray surface of the target object 14 (block 104). For example, the process 100 may involve following a standard recipe for mixing different fluids to create a fluid mixture with a hypothetical color match based on a vehicle identification number, a stock color identifier, or another suitable identifier. A user may then proceed to configure the spray coating gun 12 for the target object 14 and the fluid mixture (block 106). As the user engages the spray coating gun 12, the process 100 then proceeds to create an atomized spray of the fluid mixture (block 108). The user may then apply a coating of the atomized spray over the desired surface of the target object 14 (block 110). The process 100 then proceeds to cure/dry the coating applied over the desired surface (block 112). At query block 114, the applied coating of the fluid mixture is compared with the existing color on the target object 14 to evaluate whether a color match was achieved with the fluid mixture. If a color match was not achieved with the fluid mixture, then the process 100 returns to block 104 to adjust the color of the fluid mixture to more closely match with the existing color on the target object 14. If a color match was successfully achieved, then the process 100 proceeds to query block 116 to determine whether an additional coating is desired with the current fluid mixture. If an additional coating of the fluid mixture is desired by the user at query block 116, then the process 100 returns to blocks 108, 110, and 112 for application of another coating. If the user does not desire an additional coating of the fluid mixture at query block 116, then the process 100 is finished at block 118.

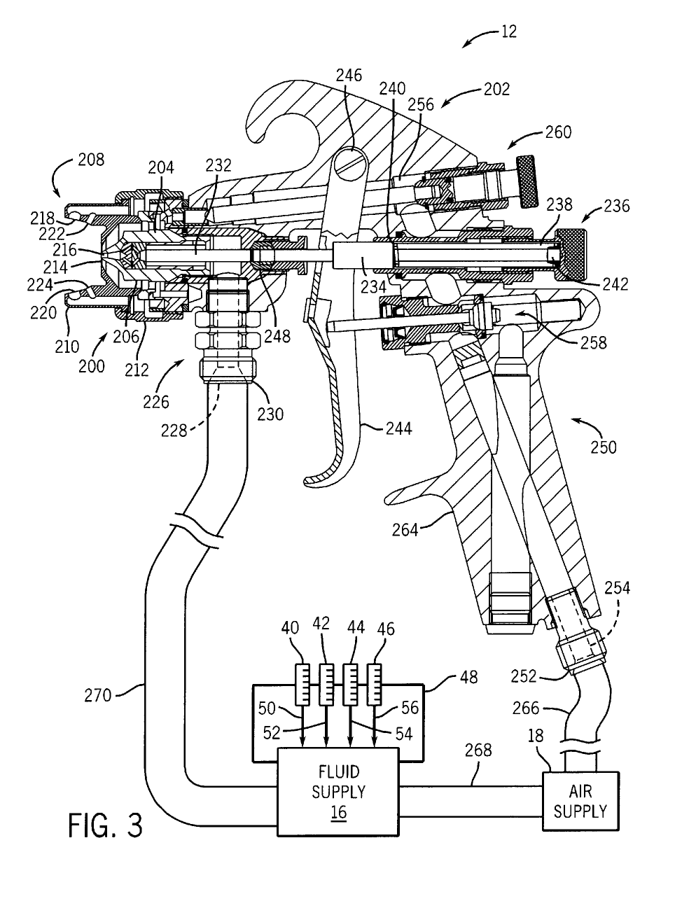

FIG. 3 is a cross-sectional side view illustrating an exemplary embodiment of the spray coating gun 12. As illustrated, the spray coating gun 12 includes a spray tip assembly 200 coupled to a body 202. The spray tip assembly 200 includes a fluid delivery tip assembly 204, which may be removably inserted into a receptacle 206 of the body 202. For example, a plurality of different types of spray coating devices may be configured to receive and use the fluid delivery tip assembly 204. The spray tip assembly 200 also includes a spray formation assembly 208 coupled to the fluid delivery tip assembly 204. The spray formation assembly 208 may include a variety of spray formation mechanisms, such as air, rotary, and electrostatic atomization mechanisms. However, the illustrated spray formation assembly 208 comprises an air atomization cap 210, which is removably secured to the body 202 via a retaining nut 212. The air atomization cap 210 includes a variety of air atomization orifices, such as a central atomization orifice 214 disposed about a fluid tip exit 216 from the fluid delivery tip assembly 204. The air atomization cap 210 also may have one or more spray shaping orifices, such as spray shaping orifices 218, 220, 222, and 224, which force the spray to form a desired spray pattern (e.g., a flat spray). The spray formation assembly 208 also may comprise a variety of other atomization mechanisms to provide a desired spray pattern and droplet distribution.

The body 202 of the spray coating gun 12 includes a variety of controls and supply mechanisms for the spray tip assembly 200. As illustrated, the body 202 includes a fluid delivery assembly 226 having a fluid passage 228 extending from a fluid inlet coupling 230 to the fluid delivery tip assembly 204. The fluid delivery assembly 226 also comprises a fluid valve assembly 232 to control fluid flow through the fluid passage 228 and to the fluid delivery tip assembly 204. The illustrated fluid valve assembly 232 has a needle valve 234 extending movably through the body 202 between the fluid delivery tip assembly 204 and a fluid valve adjuster 236. The fluid valve adjuster 236 is rotatably adjustable against a spring 238 disposed between a rear section 240 of the needle valve 234 and an internal portion 242 of the fluid valve adjuster 236. The needle valve 234 is also coupled to a trigger 244, such that the needle valve 234 may be moved inwardly away from the fluid delivery tip assembly 204 as the trigger 244 is rotated counter clockwise about a pivot joint 246. However, any suitable inwardly or outwardly openable valve assembly may be used within the scope of the present technique. The fluid valve assembly 232 also may include a variety of packing and seal assemblies, such as packing assembly 248, disposed between the needle valve 234 and the body 202.

An air supply assembly 250 is also disposed in the body 202 to facilitate atomization at the spray formation assembly 208. The illustrated air supply assembly 250 extends from an air inlet coupling 252 to the air atomization cap 210 via air passages 254 and 256. The air supply assembly 250 also includes a variety of seal assemblies, air valve assemblies, and air valve adjusters to maintain and regulate the air pressure and flow through the spray coating gun 12. For example, the illustrated air supply assembly 250 includes an air valve assembly 258 coupled to the trigger 244, such that rotation of the trigger 244 about the pivot joint 246 opens the air valve assembly 258 to allow air flow from the air passage 254 to the air passage 256. The air supply assembly 250 also includes an air valve adjuster 260 coupled to a needle 262, such that the needle 262 is movable via rotation of the air valve adjuster 260 to regulate the air flow to the air atomization cap 210. As illustrated, the trigger 244 is coupled to both the fluid valve assembly 232 and the air valve assembly 258, such that fluid and air simultaneously flow to the spray tip assembly 200 as the trigger 244 is pulled toward a handle 264 of the body 202. Once engaged, the spray coating gun 12 produces an atomized spray with a desired spray pattern and droplet distribution.

In the illustrated embodiment of FIG. 3, the air supply 18 is coupled to the air inlet coupling 252 via air conduit 266. In certain embodiments, the air supply 18 may include an air compressor, a compressed air tank, a compressed inert gas tank, or a combination thereof. In addition, the air supply 18 may be coupled to the fluid supply 16 via air conduit 268, such that the fluid mixture within the fluid supply 16 is forced to flow through a fluid conduit 270 to the fluid inlet coupling 230 of the spray coating gun 12. In this particular embodiment, the fluid supply 16 and the air supply 18 may be positioned at a remote location or on-site relative to the spray coating gun 12. Advantageously, if the fluid supply 16 is located on-site, then the user can quickly and easily adjust the color of the fluid mixture within the fluid supply 16 by adding colors or tints via the color sources 40, 42, 44, or 46, or a combination thereof.

In some embodiments, the fluid supply 16 along with the color sources 40, 42, 44, and 46 are coupled directly to the spray coating gun 12, for example, on the fluid inlet coupling 230. Thus, the fluid supply 16 may be described as a bottom-mounted, on-gun configuration. Moreover, in such an embodiment with the color sources 40, 42, 44, and 46 mounted on the fluid supply 16, the system may be described as an on-gun fluid mixing and color matching system.

FIG. 4 is a cross-sectional side view illustrating an alternative embodiment of the spray coating gun 12. As illustrated, the spray coating gun 12 includes a spray tip assembly 300 coupled to a body 302. The spray tip assembly 300 includes a fluid delivery tip assembly 304, which may be removably inserted into a receptacle 306 of the body 302. For example, a plurality of different types of spray coating devices may be configured to receive and use the fluid delivery tip assembly 304. The spray tip assembly 300 also includes a spray formation assembly 308 coupled to the fluid delivery tip assembly 304. The spray formation assembly 308 may include a variety of spray formation mechanisms, such as air, rotary, and electrostatic atomization mechanisms. However, the illustrated spray formation assembly 308 comprises an air atomization cap 310, which is removably secured to the body 302 via a retaining nut 312. The air atomization cap 310 includes a variety of air atomization orifices, such as a central atomization orifice 314 disposed about a fluid tip exit 316 from the fluid delivery tip assembly 304. The air atomization cap 310 also may have one or more spray shaping orifices, such as spray shaping orifices 318, which force the spray to form a desired spray pattern (e.g., a flat spray). The spray formation assembly 308 also may comprise a variety of other atomization mechanisms to provide a desired spray pattern and droplet distribution.

The body 302 of the spray coating gun 12 includes a variety of controls and supply mechanisms for the spray tip assembly 300. As illustrated, the body 302 includes a fluid delivery assembly 326 having a fluid passage 328 extending from a fluid inlet coupling 330 to the fluid delivery tip assembly 304. The fluid delivery assembly 326 also comprises a fluid valve assembly 332 to control fluid flow through the fluid passage 328 and to the fluid delivery tip assembly 304. The illustrated fluid valve assembly 332 has a needle valve 334 extending movably through the body 302 between the fluid delivery tip assembly 304 and a fluid valve adjuster 336. The fluid valve adjuster 336 is rotatably adjustable against a spring 338 disposed between a rear section 340 of the needle valve 334 and an internal portion 342 of the fluid valve adjuster 336. The needle valve 334 is also coupled to a trigger 344, such that the needle valve 334 may be moved inwardly away from the fluid delivery tip assembly 304 as the trigger 344 is rotated counter clockwise about a pivot joint 346. However, any suitable inwardly or outwardly openable valve assembly may be used within the scope of the present technique. The fluid valve assembly 332 also may include a variety of packing and seal assemblies, such as packing assembly 348, disposed between the needle valve 334 and the body 302.

An air supply assembly 350 is also disposed in the body 302 to facilitate atomization at the spray formation assembly 308. The illustrated air supply assembly 350 extends from an air inlet coupling 352 to the air atomization cap 310 via air passages 354 and 356. The air supply assembly 350 also includes a variety of seal assemblies, air valve assemblies, and air valve adjusters to maintain and regulate the air pressure and flow through the spray coating gun 12. For example, the illustrated air supply assembly 350 includes an air valve assembly 358 coupled to the trigger 344, such that rotation of the trigger 344 about the pivot joint 346 opens the air valve assembly 358 to allow air flow from the air passage 354 to the air passage 356. The air supply assembly 350 also includes an air valve adjuster 360 to regulate the air flow to the air atomization cap 310. As illustrated, the trigger 344 is coupled to both the fluid valve assembly 332 and the air valve assembly 358, such that fluid and air simultaneously flow to the spray tip assembly 300 as the trigger 344 is pulled toward a handle 364 of the body 302. Once engaged, the spray coating gun 12 produces an atomized spray with a desired spray pattern and droplet distribution.

In the illustrated embodiment of FIG. 4, the air supply 18 is coupled to the air inlet coupling 352 via air conduit 366. Again, embodiments of the air supply 18 may include an air compressor, a compressed air tank, a compressed inert gas tank, or a combination thereof. In contrast to the embodiment of FIG. 3, the illustrated embodiment of FIG. 4 has the fluid supply 16 directly mounted to the spray coating gun 12. In other words, the fluid supply 16 and the color sources 40, 42, 44, and 46 are arranged in an on-gun configuration, such that the user can add one or more colors to the fluid mixture without putting down the gun 12 and/or without substantially delaying the spray process. The illustrated fluid supply 16 includes a gravity feed canister or cup 368 coupled to the fluid inlet coupling 330 on a top side of the body 302. The fluid supply 16 may be described as a top-mounted on-gun configuration. Furthermore, with the color sources 40, 42, 44, and 46 mounted on the fluid supply 16, the system may be described as a top mounted, on-gun, fluid mixing, and color matching system.

The cup 368 has a tapered portion 370, which leads to an outlet connector 372 coupled to the fluid inlet coupling 330. On an opposite end from the connector 372, the fluid supply 16 includes the support 48 coupled to an open end of the cup 368. The support 48 may be removably coupled to the cup 368 via threads, a friction fit, clamps, or any suitable mount. The illustrated support 48 includes a peripheral mount portion 374, an inner panel portion 376, and an outer panel portion 378.

The color sources 40, 42, 44, and 46 are supported by receptacles 380 in the outer panel portion 378. In addition, the color sources 40, 42, 44, and 46 have outlets 382, 384, 386, and 388, which extend through passages 390 in the inner panel portion 376. In some embodiments, the passages 390 may include seals, such as o-rings, which extend around the outlets 382, 384, 386, and 388. In addition, some embodiments of the outlets include valves, such as check valves, to control flow of the color additives relative to a fluid mixture 392 within the cup 368. For example, the check valves may block flow of the fluid mixture 392 into the color sources 40, 42, 44, and 46, while enabling fluid flow of the color additives from the color sources 40, 42, 44, and 46 into the cup 368 with sufficient pressure. In certain embodiments, the color sources 40, 42, 44, and 46 are flexible squeeze bottles or tubes, syringes, pipettes, or other containers in which pressure can be applied to the color additives, thereby enabling fluid flow through the outlets 382, 384, 386, and 388 (and check valves) into the cup 368. The units of measure marks 58 also may be used to track and control the amount of color additives transferred into the cup 368.

The illustrated support 48 also includes a check valve 394 coupled to the inner panel portion 376 and a check valve 396 coupled to the outer panel portion 378. These check valves 394 and 396 function to block flow of the fluid mixture 392 out of the cup 368, while also enabling atmospheric air to flow into the cup 368 to enable the gravity feed of the fluid mixture 392 into the spray coating gun 12. Alternatively, the fluid supply 16 may include a filtered vent, a collapsible wall portion, an air supply, or a pressure balancer to facilitate the gravity feed.

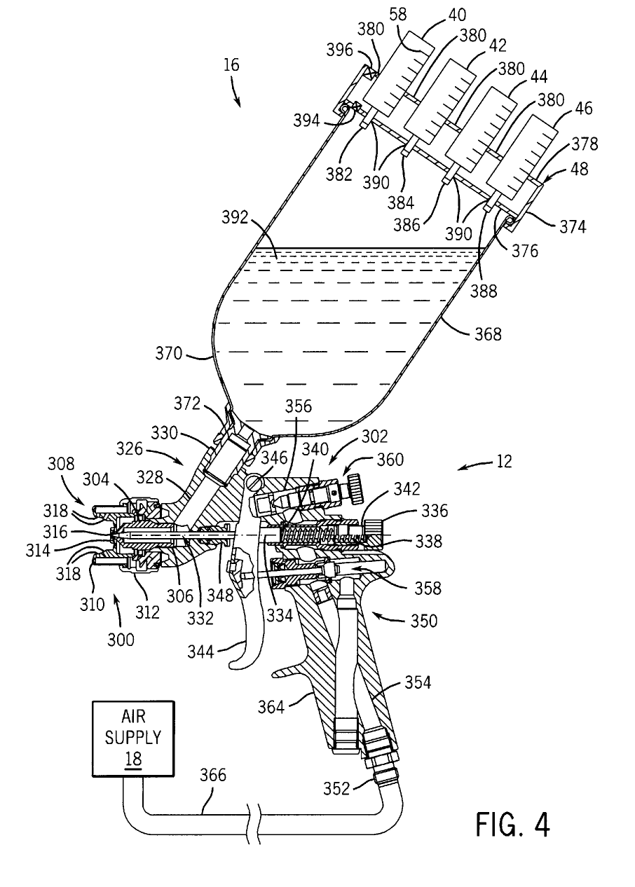

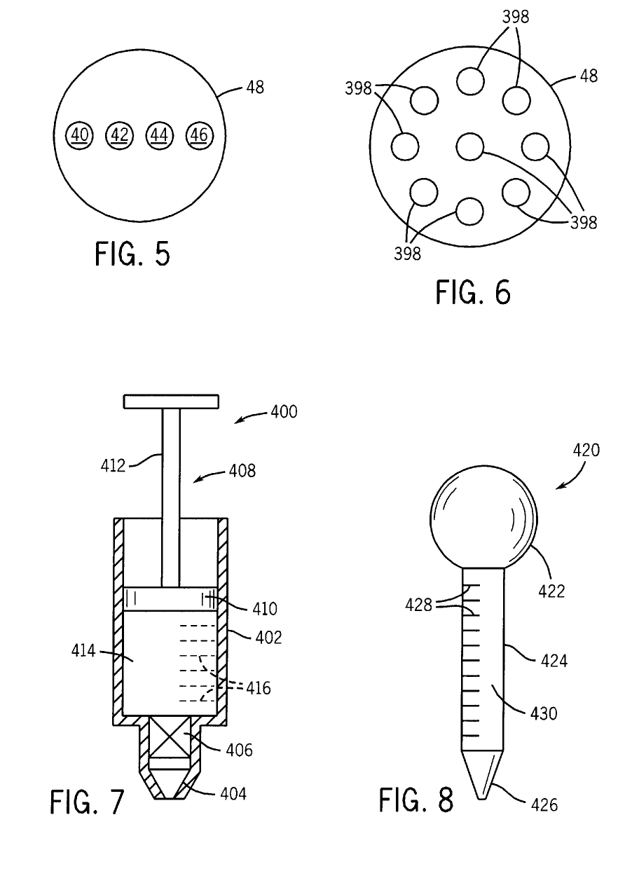

In certain embodiments, the color sources 40, 42, 44, and 46 are arranged side by side in a row on the support 48, as illustrated by the top view of FIG. 5. Alternatively, FIG. 6 is a top view of the support 48 illustrating a circular arrangement of color sources 398. Again, any number and arrangement of color sources may be employed in various embodiments of the present technique. Furthermore, the color sources may be disposed in a variety of applicators. For example, in one embodiment of the color sources described above, FIG. 7 illustrates a syringe 400 having a barrel 402 leading to an outlet tip 404, wherein the outlet tip 404 includes a check valve 406. The syringe 400 also includes a plunger 408 having a plunger head 410 coupled to a pushrod 412, wherein the plunger head 410 is disposed movably within the barrel 402. Upon depressing the pushrod 412, the plunger head 410 forces a color additive 414 to flow through the check valve 406 and out through the tip 404. The syringe 400 also includes volumetric marks 416 on the barrel 402 to enable the user to control the amount of color additive 414 injected into the fluid mixture. One or more of these syringes 400 can be used to supply color additives or tints into the fluid mixture as described in detail above.

FIG. 8 is a diagram of another embodiment of the color sources described above, specifically illustrating a bulb-type pipette 420 having a bulb 422, an elongated tube or color additive chamber 424, and a tip 426. In general, a pipette 420 functions by creating a vacuum above the color additive chamber 424 and by selectively releasing this vacuum to draw up and dispense liquid. Thus, the illustrated bulb 424 is a flexible, squeezable bulb. The tube 424 also includes measurement marks 428 to enable a user to control the amount of color additive 430 injected into the fluid supply 16.

Again, the disclosed embodiments may employ a variety of containers, valves, and applicators to add the desired color additives into the fluid supply 16. However, in each of these embodiments, the user is able to quickly add the desired color additives directly into the fluid supply 16, rather than remotely mixing colors after separating the fluid supply 16 from the system. Moreover, some of the disclosed embodiments incorporate the color sources 40, 42, 44, and 46 along with the fluid supply 16 directly on the spray coating gun 12 for on-gun fluid mixing and color matching. Thus, a user can quickly adjust the color of the fluid mixture during a spraying process (e.g., in operation), such that downtime can be substantially reduced or eliminated and color matching is more quickly achieved for the particular target object 14.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

1. A system, comprising:
a fluid container configured to mount on a spray device; and
a color additive applicator coupled to the fluid container.

2. The system of claim 1, wherein the fluid container comprises a gravity feed container.

3. The system of claim 1, wherein the color additive applicator comprises a syringe.

4. The system of claim 1, wherein the color additive applicator comprises a pipette.

5. The system of claim 1, wherein the color additive applicator comprises a plurality of marks for units of measurement.

6. The system of claim 1, wherein the color additive applicator comprises a check valve.

7. The system of claim 1, comprising a plurality of color additive applicators including the color additive applicator.

8. The system of claim 7, wherein the plurality of color additive applicators are configured to supply different colors to the fluid container to create a desired color mixture.

9. The system of claim 1, comprising the spray device having the fluid container coupled thereto.

10. The system of claim 9, wherein the fluid container is mounted to a top portion of the spray device.

11. A system, comprising:
a color matching support configured to receive a plurality of different color sources, wherein the color matching support is configured to enable the plurality of different color sources to provide different colored additives to a fluid mixing chamber of a spray device.

12. The system of claim 11, wherein the color matching support comprises a cover configured to couple to a fluid supply container having the fluid mixing chamber.

13. The system of claim 12, comprising the fluid supply container configured to couple to a fluid inlet of the spray device.

14. The system of claim 13, comprising the spray device having the fluid container coupled to a top side opposite from a trigger of the spray device.

15. The system of claim 11, wherein the plurality of different color sources comprises a syringe, a pipette, a squeezable applicator, or a combination thereof.

16. The system of claim 11, wherein the plurality of different color sources comprises a check valve, a pinch valve, an electronic valve, or a combination thereof.

17. A system, comprising:
a color additive applicator configured to couple to a fluid container disposed on a spray coating device.

18. The system of claim 17, wherein the color additive applicator is configured to mount to a cover of the fluid container.

19. A method, comprising:
adding one or more colors from different color sources directly into a fluid container disposed on a spray device to adjust color of a fluid within the fluid container, wherein the different color sources are mounted to the fluid container.

20. The method of claim 19, comprising shaking the fluid container along with the spray device to mix the one or more colors with the fluid.
